(19) United States
(12) Patent Application Publication
(10) Pub. No.: US 2022/0074222 A1
(43) Pub. Date: Mar. 10, 2022

(54) LIFTING DEVICE FOR POSITIONING AND ORIENTING A POLE

(71) Applicant: Preben Kristensen, Guldborg (DK)

(72) Inventor: Preben Kristensen, Guldborg (DK)

(21) Appl. No.: 17/017,605

(22) Filed: Sep. 10, 2020

(51) Int. Cl. E04H 12/34; B66C 1/44

(52) U.S. Cl. CPC E04H 12/347; B66C 1/44

(57) ABSTRACT

A lifting device for poles, such as a mast for a sailing ship, a Christmas tree, a pole for supporting wires or the like, are either raised to a vertical position or laid down to a horizontal position, i.e. the lifting device may be used both when a pole is brought from a horizontal to a vertical position and when a pole is brought from a vertical to a horizontal position.

### FIELD OF THE INVENTION

The present invention relates to a device for positioning and orienting a pole. In particular, the device is to be used when poles, such as a mast for a sailing ship, a pole for supporting wires or the like, are either erected or laid down, i.e. the lifting device may be used both when a pole is brought from a horizontal to a vertical position and when a pole is brought from a vertical to a horizontal position.

### BACKGROUND

Generally, conventional systems consist in establishing of a fixed grip on a pole, so that a point or points of contact can support the pole in both a horizontal and a vertical position and move the pole in a controlled manner from one position to the other.

U.S. Pat. No. 1,908,146 A (Glen, Helton) discloses a device used when erecting poles for example poles supporting wires which device may be released from the poles by a person standing on the ground. The device comprises a sling consisting of a body portion 5 provided with parallel flanges 6 and 7 which flanges are connected by a web 8. The web 8 is provided with slots 9 and 10 at opposite ends of the body portion 5. The end 11 of a flexible member such as chain 12 is passed into the slot 9 and a pin 13 is used to holding the end 11 securing this end of the flexible member permanently to the body portion 5. The other end of the flexible member 12 is secured releasably to the body portion 5. To release the chain 12 from the body portion 5, a line 18 is pulled moving a pin 16 against the thrust of a spring 19 thereby releasing the flexible member 12 from the pole. This lifting device is not suitable for bringing a pole from a vertical to a horizontal position, as it is necessary to tighten the flexible member manually, also the loose end of the flexible member could get caught in the body portion 5 and prevent release of the sling or the loose end could be pulled accidently before the pole is in vertical position causing the pole to fall back to a horizontal position.

WO2014/079454 discloses a gripping tool (1) for fixing an elongate object (12), such as a pole or a mast. The gripping tool (1) comprises a first gripping device (22) and a second gripping device (23), both gripping devices (22, 23) comprises at least one gripping arm (19) arranged to act on the object (12). The gripping tool (1) further comprises a gripping actuator (24) being connected to at least one gripping arm (19) of both gripping devices (22, 23) so that the gripping actuator (24) drives the gripping action of both of the first gripping device (22) and the second gripping device (23). The gripping devices (22, 23) are arranged so that the gripping action of the first gripping device (22) is substantially at least partially independent of the gripping action of the second gripping device (23). The movable parts of the gripping device (22, 23) are configured to have two positions, a first position where the movable parts form a closed loop and a second position where the movable parts form an open loop providing an opening allowing a pole to exit or enter into the loop. None of the movable parts are configured to move along a linear track between a first and a second position.

### SUMMARY

The lifting device of the present invention provides an improved tool for moving a pole between a horizontal and a vertical position, the lifting device may be used for both raising and lowering of poles.

Also, the lifting device can be used to move poles having varying diameter or poles having branches and the closing and release mechanisms of the lifting device may be controlled from a distance in a safe manner.

According to a first aspect, the invention relates to a lifting device for moving a pole between a horizontal and a vertical position comprising

a frame;

at least one movable part configured to have at least two positions, a first position where the movable part(s) alone or together with the frame forms a closed loop and a second position where the movable part(s) alone or together with the frame forms an open loop providing an opening allowing a pole to exit or enter into the loop;

a closing mechanism comprising means for attaching, fixing or connecting the closing mechanism (4) to the at least one movable part;

a release mechanism comprising means for attaching, fixing or connecting the release mechanism to the at least one movable part(s) and means for activating the release mechanism from a distance;

fastening means fixing the lifting device to the pole at an operational position;

wherein each movable part is made of one or more rigid pieces forming a non-flexible part and the closing mechanism comprises means for activating the closing mechanism from a distance and the lifting device may comprise one movable part extending in a longitudinally direction and configured to move along a linear track in this longitudinal direction between a first and a second position, and the frame comprises guiding means defining the linear track.

According to any embodiment of the invention, the frame may be configured to be attached to a powered lifter.

According to any embodiment of the invention, the movable part(s) may (each) be attached to the frame in such a way that the movable part(s) can move relative to the frame e.g. by sliding or linearly or by rotation.

That the movable part(s) is/are constructed of rigid materials makes it possible to control, not only the exact start and end position of a movable part, but also the route that a movable part(s) travels when changing position. This means that it is possible to close the loop high up while standing on the ground i.e. at a distance.

According to any embodiment of the invention, the lifting device comprises at least two movable parts (2). The lifting device may comprise one, two, three or more movable parts which are moved simultaneously or individually.

According to any embodiment of the invention, each movable part during opening or closing of the loop may be configured to move by a sliding movement, a rotational movement or a combination of a sliding and rotational movement between the first and second position relative to the frame.

According to any embodiment of the invention, the lifting device may comprise at least one movable part extending in a longitudinally direction and being rotationally fixed to the frame at one end such that the movable part(s) may swing from one position where a closed loop is formed to a second position where an open loop is formed around the fixing point.

According to any embodiment of the invention, the closing mechanism may be a flexible member such as a rope, a line, a chain or the like.

According to any embodiment of the invention, the release mechanism may be a flexible member such as a rope, a line, a chain or the like.

According to any embodiment of the invention, the frame may comprise a balancing element comprising guiding means for either the release mechanism or the closing mechanism.

According to any embodiment of the invention, a balancing element may be attached to the frame during operation, which balancing element has a weight and weight distribution i.e. size, allowing the balancing element to balance the frame of the lifting device in a horizontal position.

According to any embodiment of the invention, the closing mechanism may be constituted of a flexible member such as a rope or a line or a chain, which flexible member is fixed to the movable part at one end and attached to or fixed to the pole, normally the lower end of the pole, during lifting.

According to any embodiment of the invention, the closing and release mechanisms may be construed as a single part or tool such as a flexible cable transferring mechanical power or energy by moving an inner cable normally of steel or stainless steel, relative to a hollow outer cable housing which cable housing is composed of a flexible structure e.g. consisting of a screw-shaped steel wire, often lined with nylon and with a plastic outer sheath.

According to any embodiment of the invention, the lifting device may comprise a separate part configured to transfer the power from a crane or hoist or other lifting facility to the pole, e.g. comprising a rope or a chain or a cable connected to the crane or hoist or other facility at one end and connected to the pole at the other end. According to this embodiment, the separate part may comprise the fastening means (10).

Definitions:

“Pole”—when the word “pole” is used in the present document it refers to parts comprising or being constituted of a long body of wood or metal or another material such as plastic, polymer, concrete or the like, typically mounted with one end placed in a hole in the ground or at another adapted surface adapted to receive the pole, normally a pole provides a support for something. In this context “long body” means that the length of the body is at least 20 times larger than the maximum width of the body. The long body may comprise branches or other mountings, have a varying cross-section or be constructed of a plurality of poles being held together e.g. by a lattice structure or the like.

“A distance”—when a closing or opening mechanism is activated from “a distance”, this means that the mechanism is out of reach for a person, such as if a person is standing on the ground while the lifting device is positioned high up in the air. Normally, the opening and closing and position control mechanisms of a lifting device according to the invention are configured to function as remote-control tools for an operator standing approximately between 2-30 meters from the lifting device when operating the device.

“Linear track”—in this context the “track” is considered to be a route along which a movable part moves or progresses, and that the track is linear means that the track extends at least in one direction corresponding to a line and especially a straight line and the movable part may move in two directions—back and forth—relative to the track. The frame is provided with guiding means guiding the movable part along the linear track. The linear track may be straight but may also deviate slightly from a straight line e.g. deviate less than 30° from a straight line, e.g. less than 20°, or e.g. less than 10° or e.g. less than 5°, where “deviation” means that a movable part moves in one direction when leaving a first position, but has deviated from the straight line when reaching a second position.

“In general”—if a feature is described by these words it may be used in context with all embodiments according to the invention.

### BRIEF DESCRIPTION OF THE FIGURES

These and other characteristics of the present invention will be more fully understood by reference to the following detailed description in conjunction with the attached drawings, in which:

FIG. 1 is a FIG. 1 shows an assembled first embodiment of a lifting device according to the invention.

FIG. 2 shows a frame of the first embodiment.

FIG. 3 shows a movable part of the first embodiment.

FIG. 4 shows a balancing element of the first embodiment.

FIG. 5 shows an example of a support part for the frame of the first embodiment.

FIGS. 6A and 6B show an assembled second embodiment of a lifting device according to the invention comprising release, closing and guiding mechanisms. FIG. 6A shows the device in a closed state and FIG. 6B shows the device in an open state

FIG. 7 shows a lifting device mounted on a pole.

FIG. 8A and 8B show a second embodiment of a lifting device according to the invention.

FIGS. 9A, 9B and 9C show the second embodiment of the lifting device in different positions of openness or i.e. in varying degrees of an open loop.

### DETAILED DESCRIPTION

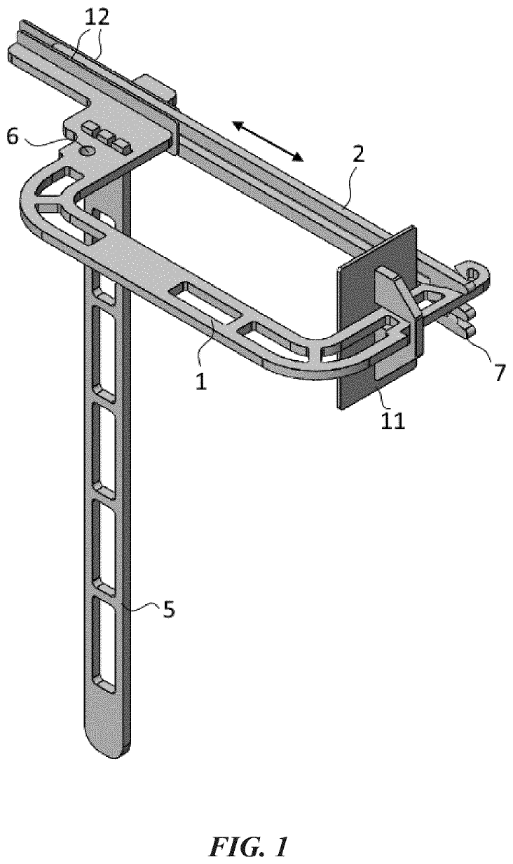

FIGS. 1 through 9C, wherein like parts are designated by like reference numerals throughout, illustrate an example embodiment or embodiments of a pole positioning and orienting device, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention. A lifting device according to the present invention comprises a frame 1 configured to be attached to a powered lifter 16 such as a crane or a hoist either permanently or releasably, the frame 1 may comprise or be fixed to a balancing element 5 extending in the vertical direction during use, the length and weight of the balancing element 5 may be adapted to the actual embodiment and used to keep the frame relatively horizontal during use. The lifting device comprises at least one movable part 2, 2a configured to have at least two positions, a first position where one or more movable part(s) 2, 2b, 2c alone or together with the frame 1 forms a closed loop where the lifting device is in a closed state, and a second position where the one or more movable part(s) 2, 2b, 2c alone or together with the frame 1 forms an open loop where the lifting device is in an open state providing an opening being large enough to allow a pole to exit or enter sideways into the loop.

According to any embodiment of the invention, at least one movable part 2, 2a extends in a longitudinally direction and is configured to move along a linear track in the longitudinal direction between a first and a second position. The frame 1 may comprise guiding means 12 defining the linear track and the movable part 2 comprises corresponding means corresponding to the guiding means of the frame 1.

According to one embodiment, the guiding means 12, 12a, 12b, 12c may be one or more protruding part(s) 12a e.g. extending from a surface of the frame 1 e.g. in combination with separate locking means 12b, and the corresponding means 12c of the movable part 2 may be longitudinal opening. Alternatively, the guiding means 12 may be one or more rings or conduits guiding the movable part 2 inside the ring/conduit.

According to a second embodiment, the guiding means 12 may be a longitudinal opening in the frame 1 e.g. in the balancing element 5 of the frame, and the corresponding means 12c of the movable part 2a may be one or more protruding parts.

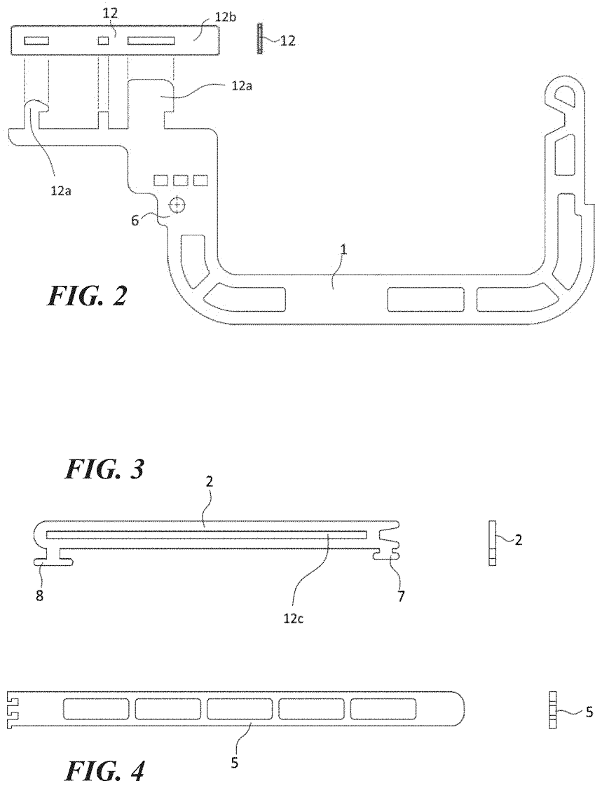

According to the embodiment of FIG. 1, the guiding means 12 comprises a combination of protruding parts 12a having locking means in form of hook parts and a plate 12b comprising openings through which the protruding parts 12a with hook parts may be positioned during use. A moving part 2 to be used with the shown guiding means 12 may comprise a longitudinal opening 12c. During use, the protruding parts 12a of the guiding means 12 are fitted into the opening of the movable part 2, then the plate 12b having openings corresponding to the protruding parts 12a is pushed down over the protruding parts and locks the movable part 2 in this direction i.e. the direction perpendicular to the longitudinal direction. However, the movable part 2 may move freely in the longitudinal direction. FIG. 2 shows a part of the frame 1 of the first embodiment separated from the other parts and illustrates how the elements of the guiding means 12 should be assembled as openings in the locking part 12b may be pushed over the protruding parts 12a.

FIG. 3 show the movable part 2 of the first embodiment which comprises means 8 for attaching and closing mechanism 4 in form of a T-shaped protrusion allowing easy fastening of a rope or the like. Also, the movable part 2 comprises means 7 for attaching a release mechanism 3 in form of a T-shaped protrusion allowing for easy fastening of a rope or the like. Further, the movable part 2 comprises corresponding means 12c constituted of a longitudinal opening in which opening protruding parts 12c of the frame 1 may slide back and forth.

FIG. 4 shows a balancing element 5 separated from the frame 1. During use the balancing element 5 will be fixed to the frame 1 and as such be a part of the frame 1. When the lifting device during use is hanging freely, the balancing element 5 will balance the horizontal part of the frame and make it easier to position the frame 1. Therefore, the size and the weight of the balancing element 5 will be adapted to the horizontal part of the frame.

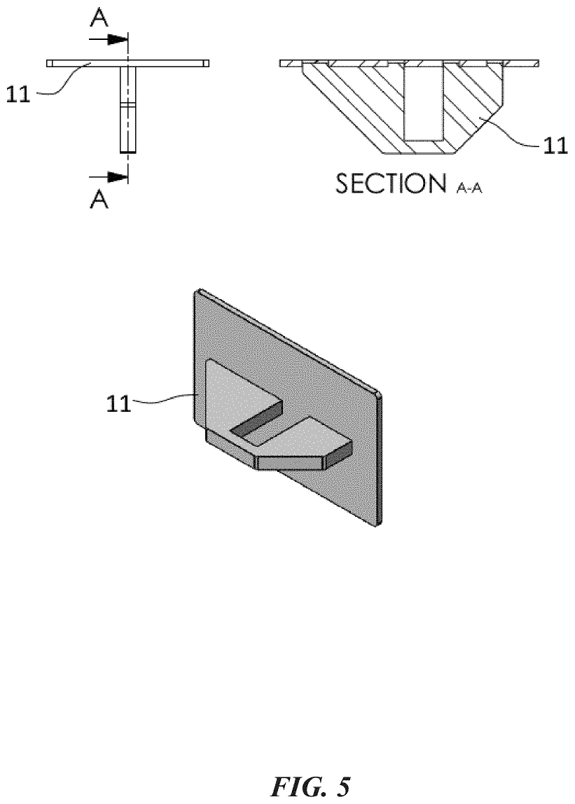

FIG. 5 shows a support part 11 for the frame 1, the support part 11 help keeping the frame 1 horizontal relative to a pole embraced or surrounded by the frame 1/movable part 2.

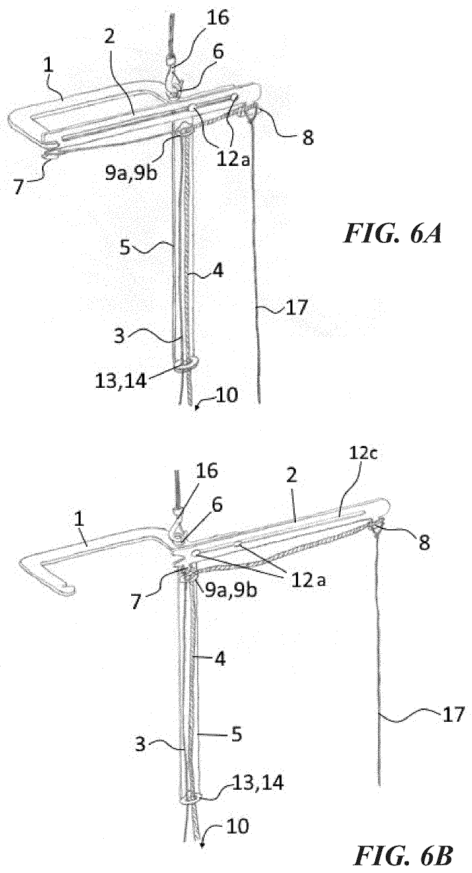

FIGS. 6A and 6B shows the first embodiment of the lifting device in respectively a closed and an open position.

In general, the lifting device may comprise a closing mechanism 4 and means 8 for attaching, fixing or connecting the closing mechanism 4 to the at least one movable part 2. The closing mechanism 4 may e.g. be constituted of a flexible member such as a rope or a line or a chain, or of a non-flexible member, also the closing mechanism may be a combination of flexible and non-flexible members or the like. If the closing mechanism 4 is a flexible member, the flexible member may at one end be tied or otherwise fastened to the means 8 of the movable part 2 and the means 8 may be constituted of an eye bolt or not. The closing mechanism 4 may be activated or operated from a distance, i.e. the closing mechanism 4 comprises either a mechanical member having a physical length making it possible for a user to activate or operate, i.e. close, the movable part(s) 2 when standing on the ground while the lifting device is e.g. mounted at the upper half of a pole, or the closing mechanism 4 comprises an electronic member which may be activated or operated by a signal being either wired or wireless.

In general, the lifting device may further comprise a release mechanism 3 comprising means 7 for attaching, fixing or connecting the release mechanism 3 to the at least one movable part(s) 2, also, it comprises means for activating the release mechanism 3 from a distance. Like the closing mechanism 4, the release mechanism 3 may e.g. be constituted of a flexible member such as a rope or a line or a chain or the like, and if the release mechanism 3 is a flexible member, the flexible member may at one end be tied or otherwise fastened to the means 7 of the movable part 2. The release mechanism 3 may be activated or operated from a distance, i.e. the release mechanism 3 comprises either a mechanical member having a physical length making it possible for a user to activate or operate i.e. open, the movable part(s) 2 when standing on the ground while the lifting device is e.g. mounted at the upper half of a pole, or the release mechanism 3 may comprise an electronic member which may be activated or operated by a signal being either wired or wireless. Alternatively, the release mechanism 3 may comprise or be constituted of an elastic spring which either pushes or pulls the movable part(s) 2 relative to the frame 1, or of a mass being attached to the movable part(s) 2 and pulling the movable part(s) 2 relative to the frame 1, the spring or mass will then permanently force the movable part(s) 2 into the second position forming an open loop when the closing mechanism 4 is not activated. The closing mechanism 4 will then need to be permanently activated to keep the loop closed, and this may be done by letting the closing member 4 be constituted by a flexible member such as a rope which is not only pulled upon closing but which is afterwards fixed to the lower end of the pole to be lifted, e.g. by tying a knot. In this case, the release mechanism 3 does not need to be activated upon opening as it is permanently activated. The lifting device may be provided with either a closing mechanism or a release mechanism 3 which is permanently activated, and which is therefore operated by being forcing the movable part(s) 2 into the opposite position. In general, the closing and the release mechanisms may be construed as a single part or tool configured to bring the movable part 2 both into the open position and into the closed position, such as a flexible cable transferring mechanical power or energy by moving an inner cable normally of steel or stainless steel, relative to a hollow outer cable housing which cable housing is composed of a flexible structure e.g. consisting of a screw-shaped steel wire, often lined with nylon and with a plastic outer sheath. Such pull/push cables are generally known.

In general, either the frame 1 or the moving part(s) 2 may be provided with a support part 11 providing an increased support surface for the pole to be either raised or lowered. Such a support part 11 may level the pressure of the pole against the lifting device and prevent damages to the pole and/or the lifting device.

In the context of the present document “a distance” in general means that the device is out of reach for a person operating the device, the closing and/or opening mechanism(s) is a tool configured to allow operation of the lifting device without being able to touch the lifting device. I.e. a distance may be defined as above 2 or 3 meters, normally be between 2 and 30 meters, where the distance is the distance between the lifting device to be operated and the operator.

In a lifting device according to the invention, the movable part 2, or if there are more than one movable part 2, then each movable part 2, is made of one or more rigid pieces forming a non-flexible part. That the pieces are rigid means that each piece—and therefore also the movable part 2 provided by such pieces—has a defined shape and size which does not change during normal working operation. I.e. a movable part 2 has the same shape and size when in open position, in closed position and when moving between open and closed positions, only the position of the movable part(s) is varied.

### Example: Bringing a Pole From Horizontal to Vertical Position Using a Lifting Device of First Embodiment

A pole 15 is positioned horizontally, normally on the ground where the pole 15 is available for an operator in its full length. The operator may therefore manually position a lifting device to the pole 15 before raising the pole 15 to a vertical position.

First, a loop constituted by the frame 1 and the movable part(s) 2 is placed in an open-state where the movable part 2 is in a second open position, in the open-state the loop has an opening large enough to let the pole 15 pass into the loop, normally either around the center of gravity of the pole or above the center of gravity of the pole. If the movements of the lower end of the pole is controlled otherwise, e.g. by placing the lower end of the pole in a hole or a tilting lock or the lower end of the pole is manually controlled, then the loop of the lifting device may be placed below the center of gravity.

The loop is then closed as the movable part 2 is moved to the first closed position along a linear track as the protruding parts 12a of the frame 1 slides along the corresponding opening 12c, this may be done either manually or by activating the closing mechanism 4. How the movable part is brought from a first to a second position will depend on the embodiment of the lifting device.

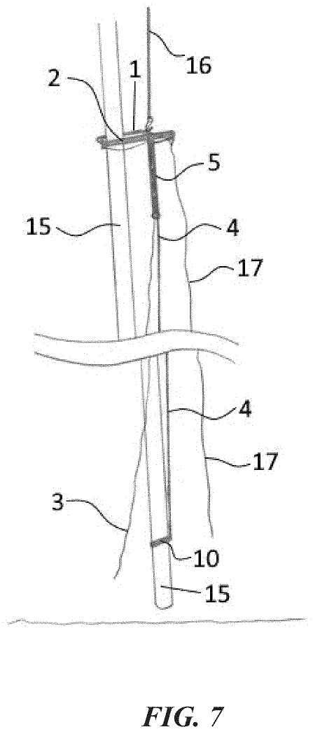

Then the lifting device is fastened to the pole 15 at a fastening point by fastening means 10 e.g. as shown in FIG. 7 the fastening point is positioned below the loop constituted of the frame 1 and the movable part(s) 2 close to the lower end of the pole 15. In general, it is advantageous if the lifting device has a fastening point relatively close to the foot of the pole 15 as the fastening means 10 may then be attached manually to the pole even when the pole is in upright position. Alternatively, the fastening means 10 may be connected directly to the powered lifter 16, e.g. by connecting a flexible or non-flexible member to the powered lifter 16 and to the lower end of the pole 15 thereby forming a connection able to transfer the force needed to lift the pole 15.

Either before or after closing the movable part 2, a powered lifter 16 such as a crane or a hoist may be attached or fixed to the frame 1 at a position 6 on the frame 1.

According to an embodiment of the lifting device the movable part 2 is constituted by a longitudinal piece, which piece at one end is provided with means 7 for attaching, connecting or fixing the release mechanism 3 to the movable part 2, and at the opposite second end the piece is provided with means 8 for attaching or connecting or fixing the closing mechanism 4 to the movable part 2. The release mechanism 3 may be constituted by a flexible member such as a rope or a line which is fixed to the means 7 e.g. by a knot or the like, and the means 7 may be an eye bolt or nut. The closing mechanism 4 may be constituted by a rope or a line which is fixed to the means 8 e.g. by a knot or the like, and the means 8 may be an eye bolt or nut.

When the release mechanism 3 is constituted of or comprises a flexible part such as a rope or a line, then the movable part 2 or the frame 1 or a balancing element 5 may comprise guiding means 13, such as a semi-closed or fully closed track, one or more U-bolts or eye bolts or nuts or other guiding means, directing the flexible release mechanism 3 from the means 7 to a shifting point 9a defining a change of direction for power exercised on the movable part 2 by the release mechanism 3 and further in direction to a user placed on the ground.

When the closing mechanism 4 is constituted of or comprises a flexible part such as a rope or a line, then the movable part 2 or the frame 1 or a balancing element 5 may comprise guiding means 14, such as a semi-closed or fully closed track, one or more U-bolts or eye bolts or nuts or other guiding means, directing the flexible closing mechanism 4 from the means 8 to a shifting point 9b defining a change of direction for power exercised on the movable part 2 by the closing mechanism 4 and further in direction to a user placed on the ground.

According to the embodiment disclosed in FIGS. 6 and 7, the frame 1 constitutes a H-shape or a U-shape comprising two side pieces and a bottom piece, and the movable part 2 comprises a longitudinal piece able to reach from one side piece of the frame 1 to the other side piece opposite the bottom piece thereby closing a loop constituted by the three pieces of the frame 1 and the piece of the movable part 2.

The balancing element 5 may be fixed to the frame 1 close to a position 6 on the frame 1 where a lift of a pole is powered either manually or by a crane or a hoist or the like. The position 6 at which a powered lifter is attached should be configured to allow attachment of the powered lifter and should be robust enough to carry the weight of the pole.

The function of the balancing element 5 is to stabilize the position of the horizontal part of the lifting device constituting the loop, i.e. the balancing element 5 may stabilize the horizontal position of the frame 1 and the closing mechanism 4. If the device is not provided with a balancing element 5, it may—depending on the construction of the frame and movable part(s) constituting the loop—be difficult to keep the loop-members in a horizontal position and capture the pole at a distance. The longer and heavier the balancing element 5 is, the more stability will be experienced during operation of the device while the device is hanging freely in the air. The optimized size of the balancing element 5 will be determined by the size and weight of the horizontal parts of the device. Alternatively, one or two or more e.g. a plurality of flexible or non-flexible members may be attached to the lifting device e.g. the frame 1, and be operated at a distance by the user, thereby making it possible to position the lifting device relative to a pole 15.

The fastening means 10 and the closing mechanism 4 may be constituted of a single flexible member such as a rope, a line, a chain or the like, where one end of the flexible member is fixed to the means 8 for fixing the closing mechanism, the flexible member is then mounted through guiding means 14 in form of one or more U-clamps or eye bolts or eye nuts or the like.

If the fastening means 10 and the closing mechanism 4 are constituted of a single flexible member, then the moveable part 2 may be closed by pulling the flexible member until the pole is fully enclosed by the loop formed by the frame 1 and the movable part 2 and subsequently the fastening means 10 may be fixed at the foot of the pole. The fixation of the fastening means 10 must be capable of holding the entire weight of the pole when the pole is lifted vertically. Then powered lifter such as a crane or the like is attached to the frame 1 at the position 6, and as the pole is lifted—when the lifting device is fastened at or above the center of gravity—the pole will gradually tilt from horizontal to vertical. As the pole tilts, the lifting force will gradually move from the frame 1 to the fastening means 10 and the fastening point. When the pole is in vertical position, the entire lifting force is absorbed in the fastening means 10.

The lifting device comprising the frame 1 and the movable part 2 enclosing the pole, will in the vertical position only serve to balance the pole.

When the pole is in vertical position, the pole may be fixed at the lower end and afterwards the lifting device can be removed by releasing the fastening means 10 and then activate the release mechanism 3, e.g. pull if the release mechanism is formed as a flexible member, and thereby pulling the movable part 2 into the open position where after the lifting device may be removed from the pole.

### Example: Bringing a Pole From Vertical to Horizontal Position Using a Lifting Device of the First Embodiment

The lifting device is attached to powered lifter 16 with the movable part 2 in the open position.

If the cross-section of the pole varies or the pole is provided with protruding parts, then the lifting device is raised to a height at or above the center of gravity of the pole while the movable part(s) 2 are in the open position and then the lifting device is maneuvered into position by maneuvering the powered lifter 16, and possibly by maneuvering the lifting device by pulling e.g. the closing mechanism 4 and/or possible the release mechanism 3 and/or an independent guiding mechanism 17 e.g. attached to the lifting device at a point placed at a distance from the point 6 at which the powered lifter is attached to the frame 1. The independent guiding means 17 may e.g. comprise a line hanging from the position 8 where the means for fixing a closing mechanism 4 may be attached or the independent guiding means may be a non-flexible member such as a stick or a rod.

By maneuvering the crane or hoist and possibly mechanical means hanging from the lifting device, the pole is brought through the opening of the open loop and the frame 1 and/or the movable parts are positioned around the pole so that the pole is enclosed by the frame 1 and/or the open movable part(s) 2 of the lifting device.

When the lifting device is in this position, the closing mechanism 4 is activated and the lifting device is locked around the pole as the movable part 2 closes the opening of the loop preferably at a vertical position above the center of gravity. The closing mechanism is then attached to the foot of the pole in a manner where it can absorb the entire weight of the pole axially, alternatively the pole is fixed to the crane or hoist by another connection not constituted by the closing mechanism 4.

If the cross-section of the pole does not vary to a degree which makes it impossible to mount the lifting device near the lower end of the pole, close the loop by moving the movable part(s) 2 into the closed position and then let the lifting device slide up the pole to its operational position, the pole is brought through the opening of the open loop and the frame 1 and/or the movable parts are positioned around the pole where after the movable part(s) are brought into the closed position so that the pole is enclosed by the frame 1 and/or the open movable part(s) 2 of the lifting device at a height where this procedure may be done manually. Afterwards, the lifting device is then raised to a height where lifting of the pole may take place. However, when the “pole” is e.g. a Christmas tree or similar having branches pointing to the sides it is not possible to attach a lifting device at the lower end of the pole before lowering it.

In general, the lifting device according to the invention may be applied for raising or lowering poles where the lifting device cannot encircle the entire diameter of a pole in the loop, a lifting device according to the invention may e.g. be attached to a single leg of a pole constructed with 2, 3, 4 or more legs joined by cross-bars e.g. a lattice construction, or the lifting device according to the invention may e.g. by attached to a protruding part or “eye” which is either a natural part of the pole or which protruding part may be fastened or fixed to the pole to perform lowering of the pole.

When the lifting device is positioned around the pole at an operational height then the fastening means 10 are secured to the pole 15 locking the vertical position of the lifting device relative to the pole.

Then the powered lifter 16 is activated again, and the lifting device and the pole is lifted upwards, and if the closing mechanism consists of a flexible member which also constitute the fastening means, then the closing mechanism 4 is pulled with a force approximately equal to the weight of the pole.

The pole is released from any fixation which might keep the pole in a steady or locked vertical position and then the pole may be lifted and gradually tilted while changing position from vertical to horizontal. When the pole is laid to rest in a horizontal position, the closing mechanism 4 or another connection which has provided the fastening means 10 to the pole, is released from the pole and then the release mechanism 3 is activated and the movable part 2 brought to the open position.

In general, the closing mechanism 4 may exclusively serve the purpose of moving the movable part 2 from an open to a closed position, in this case the closing mechanism 4 comprises parts configured for releasing and moving the movable part 2 into the closed position, if this is the case, the assembly constituting the lifting device will further comprise a separate part e.g. a rope or chain which provides a connection directly from the pole 15 to the powered lifter 16 which separate part then may carry the weight of the pole and the lifting device. Alternatively, a closing mechanism may comprise a part e.g. a rope or a chain, providing a connection to the crane or hoist which part is able to carry the weight of the pole and the lifting device.

When the closing mechanism 4 comprise a part transferring the lifting force to the pole e.g. by a long flexible part as shown in the embodiments of the figures, then it will not be possible to bring the movable part 2 into the open position by mistake during lifting, i.e. the construction functions as a safety device preventing that the movable part 2 is moved to the open position during lifting.

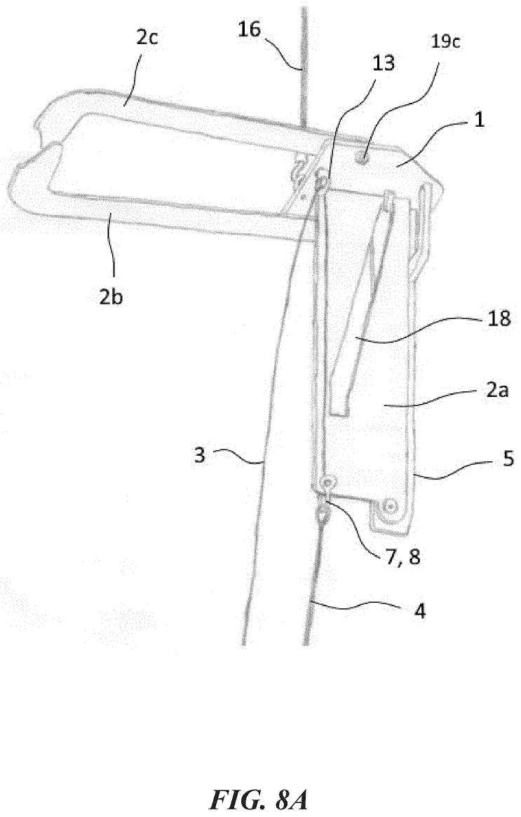

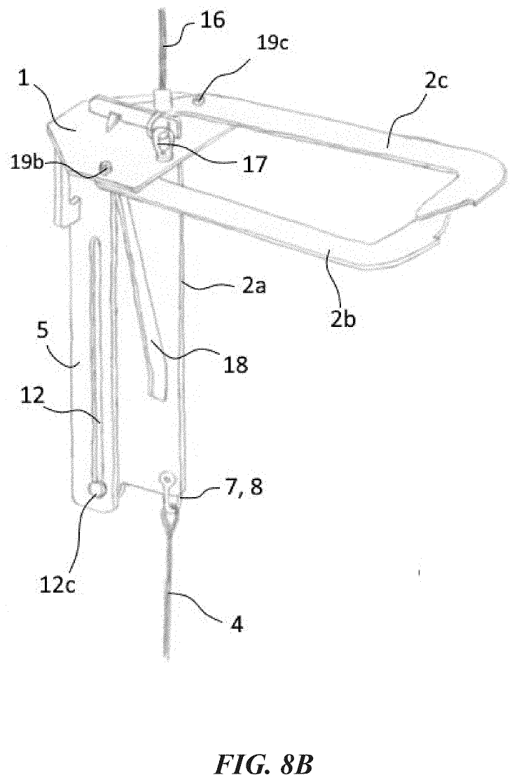

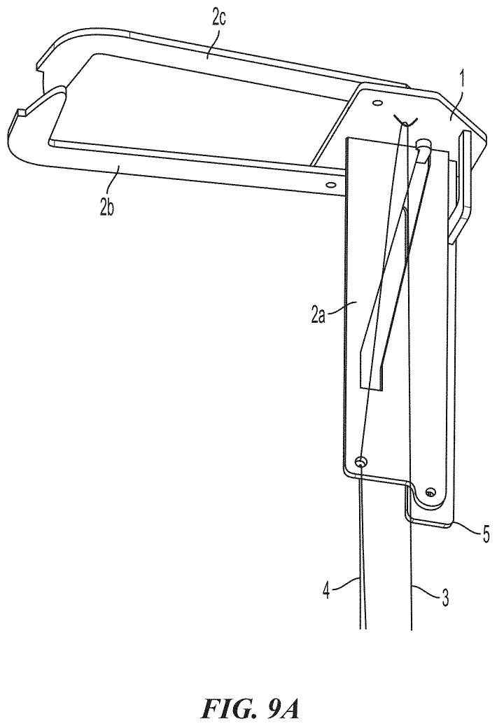

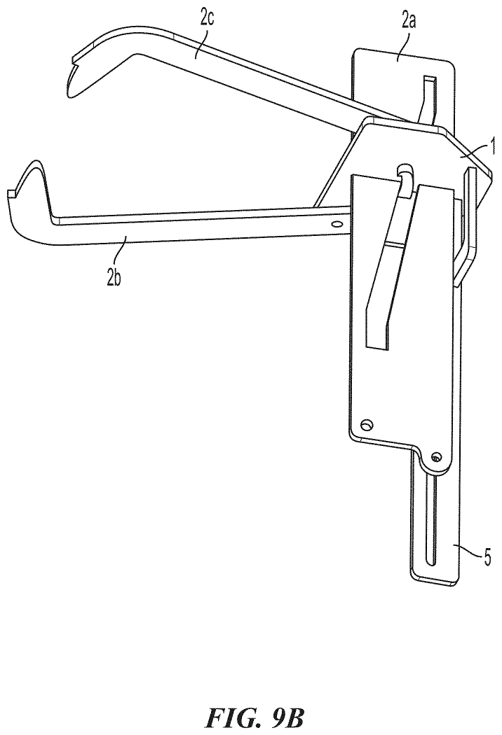

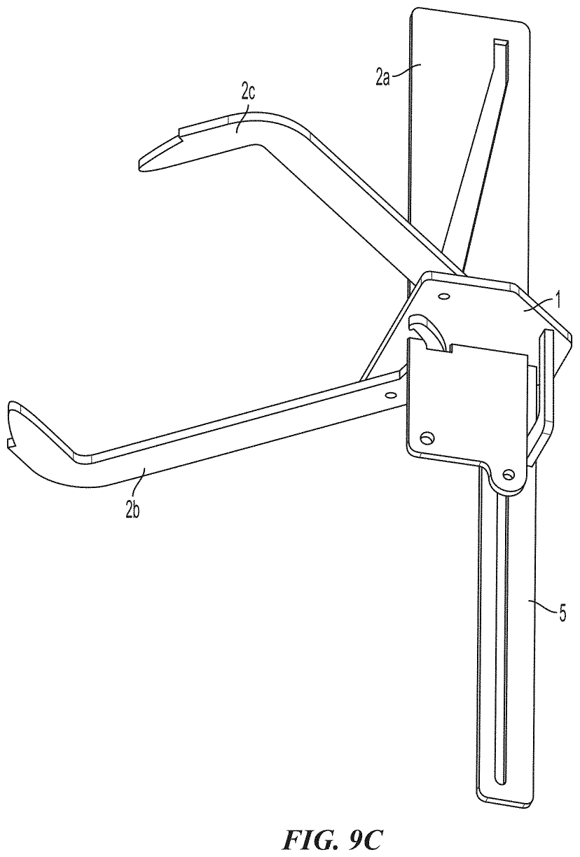

A second embodiment of a lifting device according to the invention is illustrated in FIGS. 8A and 8B, and the functionality of the second embodiment is illustrated in FIGS. 9A-9C.

The second embodiment comprises three movable parts 2a, 2b and 2c where the movable part 2a is configured to have at least two positions, a first position where the movable parts 2b and 2a form a closed loop and a second position where the movable parts 2a and 2b form an open loop providing an opening allowing a pole to exit or enter into the loop.

The movable part 2a extends in a longitudinally direction and is configured to move along a linear track in this direction between the first and the second position. The frame 1, 5 comprises guiding means 12 defining a linear track. According to the embodiment of FIGS. 8A and 8B, the guiding means 12 comprises or is constituted of a longitudinal opening in the balancing element 5 of the frame 1. The corresponding means 12c of the movable part 2a may be constituted by a protruding part e.g. a screw having a head with a diameter larger than the longitudinal opening 12 or similar locking means, or a part made of same material as the movable part 2a.

During operation, the corresponding means in form of a protruding part 12c is fitted into the longitudinal opening of the balancing element 5, and the movable part 2a may then move freely in the longitudinal direction whereas it is prevented from moving perpendicularly relative to the balancing part 5 due to the locking means.

The embodiment may comprise closing mechanism 4 and a release mechanism as the first embodiment as well as means for attaching 8, 7 a closing mechanism 4 and a release mechanism 3 to the lifting device. The closing mechanism 4 may be constituted of a rope or the like attached to the movable part 2a e.g. through an opening or eye 8 in the movable part 2a and the release mechanism 3 may be constituted of a rope or the like attached to the same or a different opening or eye 7 in the movable part 2a as the closing mechanism 4.

The release mechanism 3 comprising a rope or similar may then be connected movably to the frame 1 e.g. by leading the rope through an opening or an eye 13 or similar, and by pulling the release mechanism 3 it may then be possible to pull the movable part 2a towards the frame 1.

In general, the movable parts 2b and 2c may be pivotally mounted relative to the movable part 2a which move in a longitudinal direction. However, the two movable parts 2b and 2c may not rotate around the same rotation axis, the movable part 2b may pivot/rotate around a rotating axis 19b and the movable part 2c may pivot/rotate around a rotating axis 19c.

The movable part 2a may comprise a control track 18 which control track can control the rotation and thereby the horizontal position of the movable parts 2b and 2c, e.g. the position of the track 18 relative to the frame 1 may define the opening of the loop constituted of the two movable parts 2b and 2c.

The two movable parts 2b and 2c may extend through the track 18 at different positions, one movable part 2b may be positioned at a first side of a horizontal part of the frame 1 and the second movable part 2c may be positioned at the opposite side of the horizontal part of the frame 1, as the movable parts 2a and 2b are in sliding contact with the frame 1, the movable parts obtain an increased stability.

The width of the track 18 may be varied as well as the width or thickness of the movable parts 2b and 2c closest to the movable part 2a may be varied. The variation of the width of the track 18 in combination with the thickness of the part of the movable parts 2b and 2c may be used to control the horizontal position of the movable parts 2b and 2c relative to the movable part 2a. The interconnected movements of the three movable parts 2a, 2b and 2c are illustrated in FIGS. 9A-9C.

In FIG. 9A the ends of the movable parts 2b and 2c opposite the rotation axis 19b and 19c are overlapping providing a closed loop. The movable part 2a is at a first position which in FIG. 9A may be defined as a lowest position.

In FIG. 9B the ends of the movable parts 2b and 2c opposite the rotation axis 19b and 19c are being forced away from each other as the movable parts 2b and 2c are pivoted or rotated around each their rotation axis 19b and 19c. The movable part 2a has been pushed upward through a slit in the horizontal part of the frame 1 and is kept in correct position by the interaction between the corresponding guiding means 12 and 12c of respectively the movable part 2a and the balancing element 5 of the frame 1. The variation of the width of the control track 18 in combination with the varying width of each of the movable parts 2b and 2c together with the horizontally displaced rotation axis 19b and 19c cause the movable parts 2b and 2c to pivot or rotate.

In FIG. 9 the ends of the movable parts 2b and 2c opposite the rotation axis 19b and 19c are separated as much as possible providing a fully open loop. The movable part 2a is at a second position which in FIG. 9C may be defined as a highest position.

| Reference | |
|---|---|
| no. | Name of reference |
| 1 | Frame |
| 2, 2a, 2b, 2c | Movable part |
| 3 | Release mechanism |
| 4 | Closing mechanism |
| 5 | Balancing element of frame |
| 6 | Position on frame 1 for fixing a crane or hoist |
| | able to elevate the pole |
| 7 | Means for attaching/connecting/fixing a release |
| | mechanism 3 |
| 8 | Means for attaching/connecting/fixing a closing |
| | mechanism 4 |
| 9a | Shifting point for release mechanism |
| 9b | Shifting point for closing mechanism |
| 10 | Fastening means |
| 11 | Support part for frame or moving part |
| 12 | Guiding means for movable part defining a track |
| 12a | Protruding parts |
| 12b | Locking part |
| 12c | Corresponding means comprising a longitudinal |
| | opening in movable part |
| 13 | Guiding means for release means 3 |
| 14 | Guiding means for closing means 4 |
| 15 | Pole |
| 16 | A powered lifter such as a crane or hoist |
| 17 | Guiding means for lifting device |
| 18 | Control track |
| 19b, 19c | Rotation axis for movable parts 2b and 2c |

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A lifting device for moving a pole between a horizontal and a vertical position, comprising:
a frame;
at least one movable part configured to have at least two positions, a first position where the at least one movable part alone or together with the frame forms a closed loop and a second position where the at least one movable part alone or together with the frame forms an open loop providing an opening allowing a pole to exit or enter into the loop;
a closing mechanism comprising means for attaching, fixing or connecting the closing mechanism to the at least one movable part;
a release mechanism comprising means for attaching, fixing or connecting the release mechanism to the at least one movable part and means for activating the release mechanism from a distance; and
fastening means fixing the lifting device to the pole at an operational position;
wherein each at least one movable part is made of one or more rigid pieces forming a non-flexible part and the closing mechanism comprises means for activating the closing mechanism from a distance; and
wherein the lifting device comprises the at least one movable part extending in a longitudinally direction and configured to move along a linear track in this direction between a first and a second position, and the frame comprises guiding means defining the linear track.

2. The lifting device for moving a pole between a horizontal and a vertical position according to claim 1, wherein the at least one moveable part comprises one, two, or three movable parts.

3. The lifting device for moving a pole between a horizontal and a vertical position according to claim 1, wherein each movable part of the at least one moveable part during opening or closing of the loop is configured to move by a sliding or linear movement, a rotational movement or a combination of a sliding or linear movement and a rotational movement between the first and second position relative to the frame.

4. The lifting device for moving a pole between a horizontal and a vertical position according to claim 1, wherein the lifting device comprises the at least one movable part extending in a longitudinally direction and being rotationally fixed to the frame at one end such that the at least one movable part swings from one position where a closed loop is formed to a second position where an open loop is formed around a fixing point.

5. The lifting device for moving a pole between a horizontal and a vertical position according to claim 1, wherein the closing mechanism is a flexible member such as a rope, a line, a chain or the like.

6. The lifting device for moving a pole between a horizontal and a vertical position according to claim 1, wherein the release mechanism is a flexible member such as a rope, a line, a chain or the like.

7. The lifting device for moving a pole between a horizontal and a vertical position according to claim 1, wherein the frame comprises a balancing element, which balancing element has a weight and weight distribution i.e. size, allowing it to balance the frame of the lifting device in a horizontal position.

8. The lifting device for moving a pole between a horizontal and a vertical position according to claim 1, wherein the frame comprises a balancing element which balancing element comprises guiding means for either the release mechanism or the closing mechanism or the at least one movable part.

9. The lifting device for moving a pole between a horizontal and a vertical position according to claim 1, wherein the closing mechanism is constituted of a flexible member such as a rope or a line or a chain, which flexible member is fixed to the at least one movable part at one end and attached to or fixed to the pole, normally a lower end of the pole, during lifting.

10. The lifting device for moving a pole between a horizontal and a vertical position according to claim 1, wherein the lifting device comprises a separate part configured to transfer power from a crane or hoist or other lifting facility to the pole comprising a rope or a chain or a cable connected to the crane or hoist or other facility at one end and connected to the pole at the other end.

11. The lifting device for moving a pole between a horizontal and a vertical position according to claim 1, wherein the at least one movable part comprises three movable parts, where a first movable part comprises means for determining a degree of openness of the at least one movable parts, and where a second and a third movable part in a first position alone or together with the frame form a closed loop and in a second position alone or together with the frame form an open loop providing an opening allowing a pole to exit or enter into the loop.

12. The lifting device for moving a pole between a horizontal and a vertical position according to claim 11, wherein the second and third movable parts are rotatably mounted relative to the frame.

13. The lifting device for moving a pole between a horizontal and a vertical position according to claim 11, wherein the second and third movable parts are rotatably mounted relative to the frame, and rotation axes of the second and third movable parts are different in that they are not coinciding and are parallel.

14. The lifting device for moving a pole between a horizontal and a vertical position according to claim 1, wherein the frame and the at least one movable part comprises corresponding guiding means defining the linear track, such guiding means comprises a longitudinal opening and a protruding part where the protruding part slides inside the longitudinal opening.

15. The lifting device for moving a pole between a horizontal and a vertical position according to claim 1, wherein the frame is configured to be attached to a powered lifter.
